(19) United States
(12) Patent Application Publication
(10) Pub. No.: US 2011/0175255 A1
(43) Pub. Date: Jul. 21, 2011

(54) METHOD OF RETAINING NAIL STRIP DURING A SIDING MOLD PROCESS

(75) Inventors: Daryl Paul Wernette, Johnstown, OH (US); Douglas M. McCaskey, Sylvania, OH (US); Daniel Kerr, Rock Hill, SC (US)

(73) Assignee: Boral Stone Products LLC.

(21) Appl. No.: 13/006,680

(22) Filed: Jan. 14, 2011

Related U.S. Application Data
(60) Provisional application No. 61/295,889, filed on Jan. 18, 2010.

(51) Int. Cl. B29C 39/18; B28B 7/00

(52) U.S. Cl. 264/271.1; 249/98

(57) ABSTRACT

An apparatus configured to form masonry siding products is provided. The apparatus includes a mold having a mold cavity and a plurality of retention assemblies positioned within the mold. The plurality of retention assemblies are configured to form a temporary retaining force between the retention assemblies and a nail strip as castable material enters the mold cavity.

### CROSS REFERENCE TO RELATED APPLICATIONS

This application claims the benefit of pending U.S. Provisional Patent Application No. 61/295,889, filed Jan. 18, 2010, the disclosure of which is incorporated herein by reference.

### BACKGROUND OF THE INVENTION

A building exterior can be covered by many materials including the non-limiting examples wood, brick, stone, siding, stucco and masonry. Siding is configured to repel weather elements and protect the building or structure from the effects of weather. Additionally, siding can present a desired aesthetic appearance to the building or structure.

Siding can take many forms including the non-limiting examples of horizontal boards, vertical boards, shingles, panel materials or sheet materials. Siding can also be made from many different materials including wood, metal, polymers, masonry or composites.

Siding can be applied to various types of building structures. Some examples of building structures configured to support siding include wood or metal framework (studs) or framework covered by an intermediate layer of sheet material (sheathing). Siding can be applied to the various types of building structures with different methods including the non-limiting examples of nailing, construction adhesives or combinations thereof.

It would be advantageous if masonry siding products could be manufactured more efficiently.

### SUMMARY OF THE INVENTION

In accordance with embodiments of this invention there is provided an apparatus configured to form masonry siding products. The apparatus includes a mold having a mold cavity and a plurality of retention assemblies positioned within the mold. The plurality of retention assemblies are configured to form a temporary retaining force between the retention assemblies and a nail strip as castable material enters the mold cavity.

In accordance with embodiments of this invention there is also provided a method of forming masonry siding products. The method includes the steps of positioning a nail strip such as to form a temporary retaining force between a plurality of retention assemblies formed within a mold and the nail strip, introducing castable material into the mold and around a portion of the nail strip as the nail strip is restrained by the temporary retaining force and removing the masonry siding product after the castable material has cured by overcoming the temporary retaining force between the plurality of retention assemblies and the nail strip.

Various advantages of this invention will become apparent to those skilled in the art from the following detailed description of the invention, when read in light of the accompanying drawings.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a perspective view of a masonry siding panel;

FIG. 1a is a perspective view of one end of an extension portion of the masonry siding panel of FIG. 1 illustrating a retention aperture;

FIG. 2 is a side view, in elevation, of the masonry siding panel of FIG. 1, illustrated in an installed position;

FIG. 3 is a side view, in cross-section, of a mold for manufacturing the masonry siding panel of FIG. 1 illustrating a retention assembly;

FIG. 4 is an exploded side view of the retention assembly illustrated in FIG. 3;

FIG. 5 is a side view, in elevation, of the retention assembly illustrated in FIG. 3;

FIG. 6 is a plan view of the mold of FIG. 3 illustrating the placement of the retention assemblies of FIG. 5;

FIG. 7 is a plan view of the mold of FIG. 3 illustrating a second embodiment of retention assemblies; and

FIG. 8 is a plan view of the mold of FIG. 3 illustrating a third embodiment of retention assemblies.

Reference will now be made in detail to the present preferred embodiment of the invention, examples of which are illustrated in the accompanying drawings.

### DETAILED DESCRIPTION OF VARIOUS EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figures disclose apparatus and methods for the retention of a nail strip during the mold process of masonry siding products. The term “masonry”, as used herein, is defined to mean any casting materials representing or simulating natural stonework or brickwork. Masonry siding products can be in the form of panels, corner pieces and trim pieces. Masonry siding products can be manufactured using a mold filled with castable material flowing from a source of castable material.

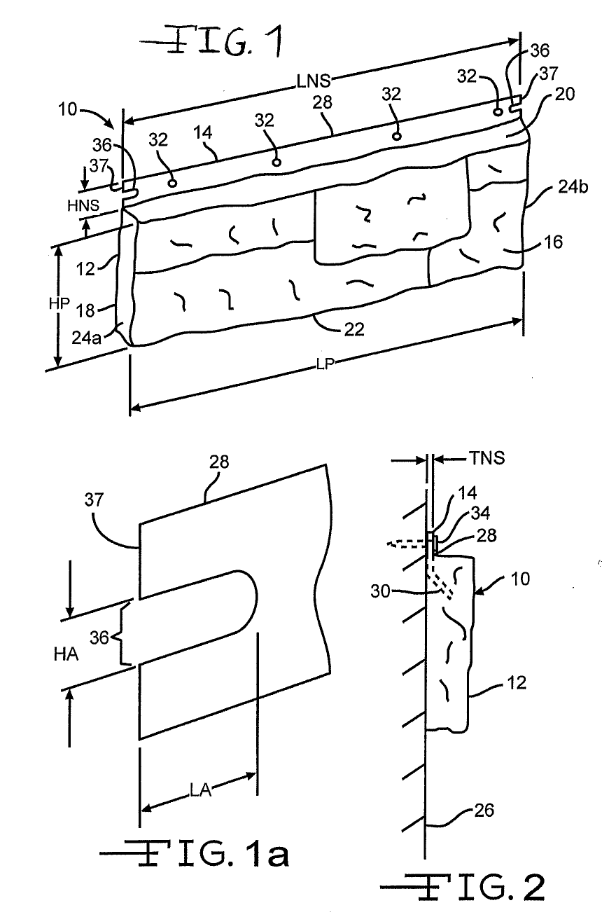

Referring now to the FIGS. 1 and 2, one example of a masonry siding product is shown generally as 10. The masonry siding product 10 includes a panel 12 and a nailing strip 14. The panel 12 has a front face 16, back face 18, top edge 20, bottom edge 22 and opposing side edges 24a and 24b. As will be explained in more detail below, the panel 12 is cast from a mold filled with castable material. In the illustrated embodiment, the front face 16, top edge 20, bottom edge 22 and opposing side edges 24a and 24b have a textured surface. The term “textured surface”, as used herein, is defined to mean an imitation of the tactile quality of a represented object. In the illustrated embodiment, the front face 16, top edge 20, bottom edge 22 and opposing side edges 24a and 24b have a textured surface that simulates natural stone. Alternatively, the front face 16, top edge 20, bottom edge 22 and opposing side edges 24a and 24b can have textured surfaces that simulate other materials, such as the non-limiting example of brick.

As shown in FIG. 1, the panel 12 has a length LP and a height HP. In the illustrated embodiment, the length LP of the panel 12 is in a range of from about 8.0 inches to about 36.0 inches and the height HP of the panel 12 is in a range of from about 4.0 inches to about 16.0 inches. In other embodiments, the length LP of the panel 12 can be less than about 8.0 inches or more than about 36.0 inches and the height HP of the panel 12 can be less than about 4.0 inches or more than about 16.0 inches. While the panel 12 illustrated in FIG. 1 is shown as having a generally rectangular shape, it should be appreciated that in other embodiments, the panel 12 can have other desired shapes, including the non-limiting example of an irregular shape.

Referring again to FIG. 1, the nail strip 14 includes an extension portion 28. The extension portion 28 of the nail strip 14 extends from the back face 18 of the panel 12 and is configured for attachment to a building structure 26 as shown in FIG. 2. Referring again to FIG. 1, the nail strip 14 can be made from any desired material, including the non-limiting example of metal.

The nail strip 14 has a thickness TNS as shown in FIG. 2. In the illustrated embodiment, the thickness TNS of the nail strip 14 is in a range of from about 16 gauge to about 26 gauge. Alternatively, the thickness TNS of the nail strip 14 can be less than about 16 gauge or more than about 26 gauge. The nail strip 14 can have any desired finish or coating. In one embodiment, the nail strip 14 can have the non-limiting coating of a rust preventative.

As shown in FIG. 1, the nail strip 14 has a length LNS and a height HNS. In the illustrated embodiment, the length LNS of the nail strip 14 is in a range of from about 8.0 inches to about 36.0 inches and the height HNS of the nail strip 14 is in a range of from about 0.5 inches to about 6.0 inches. In other embodiments, the length LNS of the nail strip 14 can be less than about 8.0 inches or more than about 36.0 inches and the height HNS of the nail strip 14 can be less than about 0.5 inches or more than about 6.0 inches. While the nail strip 14 illustrated in FIG. 1 is shown as a continuous structure, it should be appreciated that in other embodiments, the nail strip 14 can be other desired structures, including the non-limiting example of discontinuous segments.

Referring again to FIGS. 1 and 2, the extension portion 28 of the nail strip 14 has a plurality of apertures 32 spaced apart along the length LNS of the nail strip 14. The apertures 32 are configured for insertion of an anchoring member 34 as shown in FIG. 2. The anchoring member 34 is configured to attach the panel 12 to the building structure 26. In the illustrated embodiment, the anchoring member 34 is a nail. However, the anchoring member 34 can be other structures, devices or mechanisms configured to attach the panel 12 to the building structure 26, including the non-limiting example of a screw.

Referring again to FIG. 1, the extension portion 28 of the nail strip 14 includes retention apertures 36 positioned along edges 37 of the extension portion 28. Referring now to embodiment illustrated in FIG. 1a, the retention aperture 36 has the cross-sectional shape of a rounded rectangle. Alternatively, the retention aperture 36 can have other cross-sectional shapes. The retention aperture 36 has a height HA and the length LA. In the illustrated embodiment, the height HA is in a range of from about 0.125 inches to about 0.50 inches and the length LA is in a range of from about 0.25 inches to about 0.50 inches. In other embodiments, the height HA can be less than about 0.125 inches or more than about 0.50 inches and the length can be less than about 0.25 inches or more than about 0.50 inches. The retention apertures 36 will be discussed in more detail below.

Referring now to FIG. 2, the building structure 26 can be any structure suitable for siding. In one embodiment, the building structure 26 can be an exterior sheathing configured to provide rigidity to the building structure 26 and further configured to provide a surface for the exterior siding 10. In the illustrated embodiment, the exterior sheathing is made of oriented strand board (OSB). In other embodiments, the exterior sheathing can be made of other materials, such as for example plywood, waferboard, rigid foam or fiberboard, sufficient to provide rigidity to the building structure 26 and provide a surface for the exterior siding. In still other embodiments, the building structure 26 can be any desired framework including framework made from metal and/or wood studs.

Referring again to FIG. 2, the nail strip 14 includes a cast portion 30 that extends into the casted material of the panel 12 and is configured to secure the nail strip 14 to the panel 12. The cast portion 30 of the nail strip 14 can have any desired length and further can have any desired shape. In some embodiments, the cast portion 30 of the nail strip 14 is a continuous structure and has a length similar to the length LNS of the nail strip 14. However, it should be appreciated that in other embodiments, the cast portion 30 of the nail strip 14 can be other desired structures, including the non-limiting example of discontinuous segments.

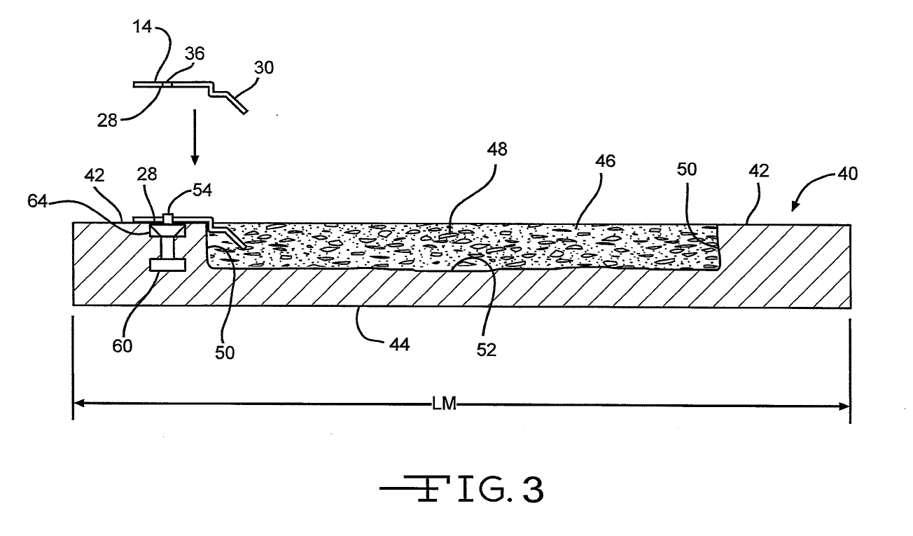

Referring now to FIG. 3, a mold 40 for manufacturing the masonry siding product 10 is illustrated. The mold 40 includes a plurality of mold walls 42 and a mold bottom 44. The mold walls 42 have a wall interior surface 50 and the mold bottom 44 has a bottom interior surface 52. The wall interior surface 50 of the mold walls 42 and the bottom interior surface 52 of the mold bottom 44 cooperate to define a mold cavity 46. Generally, the mold cavity 46 is configured to be filled with a castable material 48 as the cast portion 30 of the nail strip 14 is positioned within the mold cavity 46 and the extension portion 28 of the nailing strip 14 is positioned to extend from the mold cavity 46. After the mold cavity 46 is filled with castable material 48, the castable material 48 is allowed to cure, thereby anchoring the cast portion 30 of the nail strip 14 within the formed panel 10. Curing of the castable material 48 forms a masonry siding product 10.

Referring again to FIG. 3 and to FIG. 6, the mold 40 includes retention nubs 54. Generally, the retention nubs 54 are configured to align with and extend beyond the retention apertures 36 in the extension portion 28 of the nail strip 14 when the nail strip 14 is positioned within the mold cavity. The alignment of the retention apertures with the retention nubs 54 is configured to substantially prevent movement of the nail strip 14 relative to the mold 40. In the illustrated embodiment, the retention nubs 54 have a shape that generally corresponds to the shape of the retention apertures 36. Alternatively, the retention nubs 54 and the retention apertures 36 can have shapes different from each other sufficient to substantially prevent movement of the nail strip 14 relative to the mold 40.

Referring again to FIG. 3, the mold walls 42 and the mold bottom 44 are configured to flex when the masonry siding product is removed from the mold 40. The mold walls 42 and the mold bottom 44 can be made from one or more layers of a suitable flexible material. In the illustrated embodiment, the mold walls 42 and the mold bottom 44 are made of a urethane-based rubber material. In other embodiments, the mold walls 42 and the mold bottom 44 can be made from one or more layers of other flexible materials or combinations of flexible materials, such as the non-limiting examples of curable elastomeric, latex or silicone rubber. Optionally, the mold walls 42 and the mold bottom 44 can include one or more reinforcing materials (not shown). The reinforcing materials can be added to, or encapsulated within, the mold walls 42 and the mold bottom 44. The reinforcing materials are configured to reinforce the mold walls 42 and the mold bottom 44, yet allowing the mold walls 42 and the mold bottom 44 to still retain the desired flexibility. In certain embodiments, the reinforcing material can comprise a paste-like material, comprising, for example, a latex material, ground up rubber tires, sawdust, and MgO composition.

Referring again to the embodiment illustrated in FIG. 3, the wall interior surfaces 50 and the bottom interior surface 52 have a textured surface corresponding to the textured surface of the faces, sides and edges of the masonry siding product 10 as described above and as shown in FIG. 1.

Referring to FIGS. 3 and 6, the mold has a length LM. A plurality of retention assemblies 60 are positioned within a mold wall 42 of the mold 40 and spaced apart along the length LM of the mold 40. Generally, as will be explained in more detail below, the retention assemblies 60 are configured to provide a temporary “retention force”, thereby temporarily retaining the nailing strips 14 in a desired position during the mold process of the masonry siding products 10. The term “retention force”, as used herein, is defined to mean an attraction caused by a magnetic field. After the masonry siding products 10 have cured, the masonry siding products 10 can be easily removed from the mold 40 with the nail strip 14 embedded in the cured castable material. The retention assemblies 60 advantageously allow for fast and easy positioning of the nail strip 14 during the molding process and fast and easy removal of the cured masonry siding products following curing of the castable material 48.

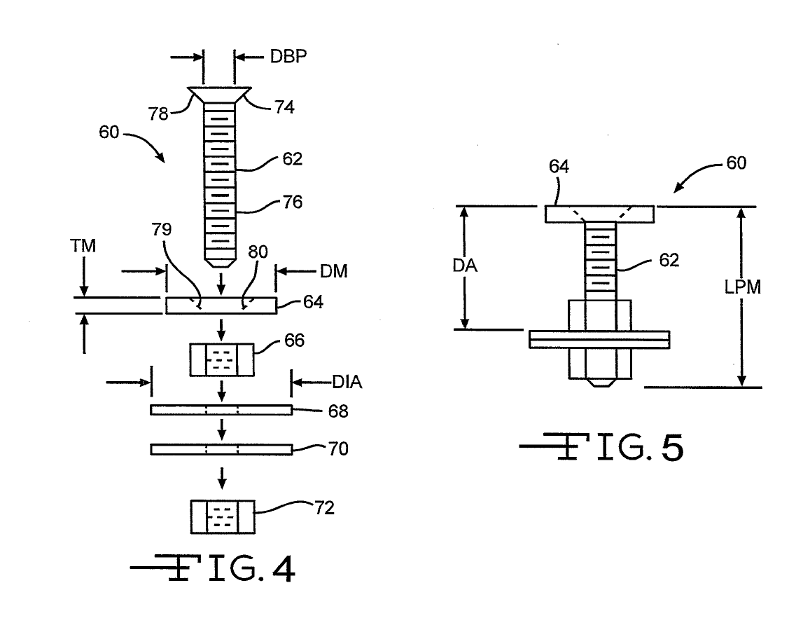

Referring now to FIGS. 4 and 5, the retention assemblies 60 are illustrated. FIG. 4 illustrates an exploded or unassembled retention assembly 60 and FIG. 5 illustrates an assembled retention assembly 60. Referring first to FIG. 4, the retention assembly 60 includes a post member 62, a magnet 64, a first fastener 66, a first anchor 68, an optional second anchor 70 and a second fastener 72.

The post member 62 is configured to provide a structure to which the magnet 64, first fastener 66, first anchor 68, optional second anchor 70 and second fastener 72 can be attached. The post member 62 includes a head portion 74 and a body portion 76. The head portion 74 of the post member 62 has a tapered annular underside 78 configured to mate with a corresponding beveled annular portion 79 of the magnet 64. While the illustrated embodiment of the post member 62 shows a tapered underside 78, it should be appreciated that the head portion 74 of the post member 62 can have other structures configured to mate with a corresponding portion of the magnet 64, including the non-limiting example of an aperture suitable for insertion of a retaining pin.

As shown in FIG. 4, the body portion 76 of the post member 62 is threaded. Threading of the body portion 76 allows the first and second fasteners, 66 and 72, to position the first anchor 68 and the optional second anchor 70, at any desired location along the body portion 76 of the post member 62. While the illustrated embodiment of the post member 62 includes the threaded body portion 76, it should be appreciated that other embodiments can have other structures configured for positioning the first and second anchors, 68 and 70, along any location of the post member 62, including the non-limiting examples of apertures and clevis pins.

Referring now to FIG. 5, the post member 62 has a length LPM. In the illustrated embodiment, the length LPM of the post member 62 is in a range of from about 0.5 inches to about 3.0 inches. In other embodiments, the length LPM of the post member 62 can be less than about 0.5 inches or more than about 3.0 inches. As shown in FIG. 4, the body portion 76 of the post member 62 has a diameter DBP in a range of from about 0.625 inches to about 1.0 inches. In other embodiments, the diameter DBP of the body portion of the post member 62 can be less than about 0.625 inches or more than about 1.0 inch.

Referring again to FIG. 4, the magnet 64 is configured to provide the retention force for temporarily retaining the nailing strips 14 in a desired position during the mold process of the masonry siding products 10. The magnet 64 has a thickness TM and a diameter DM. The thickness TM and diameter DM of the magnet 64, in combination with the magnet material, determine the retention force (or pull strength) of the retention assembly 60. As one example, a thickness of about 10 mm, a diameter of about 30 mm and a magnet material of ferrite provide a pull strength of about 1.15 kg. In the illustrated embodiment, the magnet 64 has a thickness TM of about 3.0 mm and a diameter DM of about 25.0 mm and the magnet 64 is made of a ferrite-based material. As shown in FIG. 6, this combination provides sufficient a retaining force to allow a spacing between the retention assemblies 60 of about 20.0 inches as the retention assemblies 60 are positioned in the mold 40. It should be appreciated that other combinations of magnet thickness TM, magnet diameter DM and magnet material can result in a retention force that allows spacing between retention assemblies 60 of more or less than about 20.0 inches.

As shown in FIG. 4, the magnet 64 includes a beveled aperture 80 configured to mate with the tapered underside 78 of the head portion 74. In an assembled condition as shown in FIG. 5, the upper surface of the magnet 64 is flush with the upper surface of the head portion 74 of the post member 62. It should be appreciated that in other embodiments, the upper surface of the magnet 64 can be positioned slightly above or slightly below the upper surface of the head portion 74 of the post member 62.

While the embodiment of the retention assembly 60 illustrated in FIGS. 4 and 5 shows a magnet 64 having a circular cross-sectional shape, it should be appreciated that in other embodiments, the magnet 64 can have other desired cross-sectional shapes, including the non-limiting example of a rectangular cross-sectional shape.

Referring again to FIGS. 4 and 5, when the retention assemblies 60 are positioned in the mold wall 42 of the mold 40, the first anchor 68 and the optional second anchor 70 are embedded within the material forming the mold and are configured to provide a resistive pullout force for the retention assembly 60 as the cured masonry siding product 10 is removed from the mold 40. The level of the resistive pullout force is a function of the amount of mold material between the upper surface of the first anchor 68 and the top of the mold 40. The amount of mold material between the upper surface of the first anchor 68 and the top of the mold 40 can be changed by changing the depth DA, as shown in FIG. 5, of the upper surface of the first anchor 68 or by changing the diameter DIA of the first and second anchors, 68 and 70, as shown in FIG. 4. In the illustrated embodiment, the depth DA is in a range of from about 1.0 inch to about 2.5 inches and the diameter DIA of the first and second anchors, 68 and 70, is in a range of from about 2.0 inches to about 4.0 inches. In other embodiments, the depth DA can be less than about 1.0 inch or more than about 2.5 inches and the diameter DIA of the first and second anchors, 68 and 70, can be less than about 2.0 inches or more than about 4.0 inches. While the embodiment illustrated in FIGS. 4 and 5 shows the diameter of the first anchor 68 and the diameter of the second anchor 70 to be the same, it should be appreciated that the diameters of the first and second anchors, 68 and 70, can be different from each other.

In the illustrated embodiment, the first and second anchors, 68 and 70, are made of a steel-based material. However, the first and second anchors, 68 and 70, can be made of other desired materials, including the non-limiting examples of aluminum or reinforced plastic.

While the embodiment of the retention assembly 60 illustrated in FIGS. 4 and 5 shows the first and second anchors, 68 and 70, as having a circular cross-sectional shape, it should be appreciated that in other embodiments, the first and second anchors, 68 and 70, can have other desired cross-sectional shapes, including the non-limiting example of a rectangular cross-sectional shape.

As discussed above, the second anchor 70 is optional. It should be appreciated that in some embodiments the retention assembly 60 can include the second anchor 70 and in other embodiments, the retention assembly 60 can be practiced without the optional second anchor 70.

Referring again to FIG. 3, the process for making masonry siding products 10 will now be described. In an initial step in the molding process, a mold 40 having textured wall interior surfaces 50 and a textured bottom interior surface 52 is fabricated. As a part of the mold fabrication process, the retention nubs 54 are formed. As a further part of the mold fabrication process, the retention assemblies 60 are embedded within the mold material of a mold wall 42 such that the magnet 64 is substantially flush with the top surface of the mold 40. Next the nail strip 14 is positioned on the mold 40 such that the retention apertures 36 of the extension portion 28 of the nail strip 14 align with the retention nubs 54 of the mold 40. In this position, the extension portion 28 of the nail strip 14 is in contact with the retention assemblies 60 and the cast portion 30 of the nail strip 14 is positioned within the mold cavity 46.

In a subsequent step, castable material 48 is deposited in the mold cavity 46 by any desired structure, device or mechanism, such as the non-limiting example of a hopper (not shown). The castable material 48 fills the mold cavity 46 to a desired level. As the castable material 48 substantially fills the mold cavity 46, the retention nubs 54 and the retention assemblies 60 retain the nail strip 14 in position as castable material 48 flows around the cast portion 30 of the nail strip 14. In this manner, the cast portion 30 of the nail strip 14 is cast in place within the panel 12. The castable material 48 is allowed to cure and the formed masonry siding product 10 is removed from the mold 40. As the masonry siding product 10 is removed from the mold 40, the retaining force of the retention assemblies 60 is overcome, thereby easily and quickly allowing the embedded nail strip 14 to be removed along with the formed masonry siding product 10 from the mold 40.

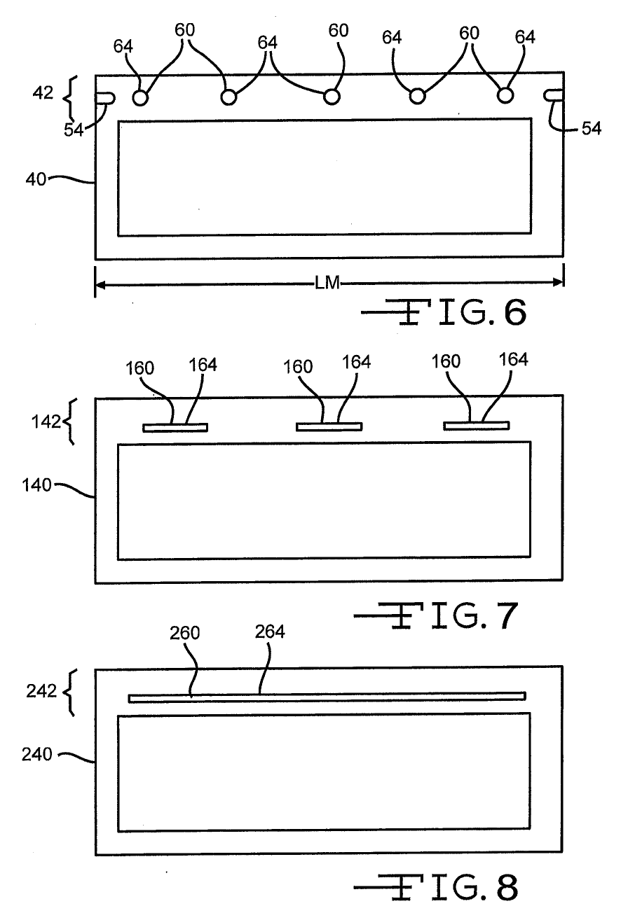

While the embodiment of the mold 40 described above and illustrated in FIGS. 3 and 6 shows retention assemblies 60 having substantially circular magnets 64, it should be appreciated that the retention assemblies 60 can have other shapes. FIGS. 7 and 8 illustrate alternate embodiments of the retention assemblies.

Referring now to FIG. 7, a mold 140 includes retention assemblies 160 positioned within a mold wall 142. The retention assemblies 160 are the same as, or similar to the retention assemblies 60 described above and shown in FIGS. 4 and 5 with the exception that magnets 164 forming a portion of the retention assemblies 160 have a rectangular shape.

Referring to another embodiment as shown in FIG. 8, the mold 240 includes a retention assembly 260 positioned in a mold wall 242. In this embodiment, the retention assembly 260 includes a magnet 264 configured to extend from one end of the mold 240 to the other end of the mold 240 as a continuous member. The magnet 264 can be anchored within the mold by the same anchoring components discussed above and shown in FIGS. 4 and 5.

The foregoing description of the various embodiments of the present invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed is:

1. An apparatus configured to form masonry siding products, the apparatus comprising:
a mold having a mold cavity; and
a plurality of retention assemblies positioned within the mold, the plurality of retention assemblies configured to form a temporary retaining force between the retention assemblies and a nail strip as castable material enters the mold cavity.

2. The apparatus of claim 1, wherein the mold includes mold walls and wherein the retention assemblies are positioned within the mold walls.

3. The apparatus of claim 1, wherein the retention assemblies include magnets, and wherein the temporary retaining force is a magnetic force.

4. The apparatus of claim 1, wherein the nail strip includes an extension portion and a cast portion, and wherein the temporary retaining force is formed between the extension portion and the retention assemblies.

5. The apparatus of claim 4, wherein the cast portion secures the nail strip to the masonry siding product.

6. The apparatus of claim 1, wherein the retention assemblies are further configured to release the nail strip after the castable material has cured and the formed masonry siding product is removed from the mold.

7. The apparatus of claim 1, wherein the retention assembly further includes at least one anchor configured to provide a resistive pullout force to the retention assembly.

8. The apparatus of claim 1, wherein the mold includes retention nubs configured to prevent movement of the nail strip during the molding process.

9. The apparatus of claim 8, wherein the nail strip includes retention apertures configured to cooperate with the retention nubs.

10. The apparatus of claim 7, where the anchor is positioned below a surface of the mold a distance of at least 1.0 inch.

11. The apparatus of claim 1, wherein the retention assemblies includes a magnet having a beveled annular aperture.

12. The apparatus of claim 1, wherein the retention assemblies include a magnet that extends substantially across a length of the mold.

13. The apparatus of claim 7, wherein the at least one anchor has a circular cross-sectional shape.

14. A method of forming masonry siding products, the method comprising the steps of:
positioning a nail strip such as to form a temporary retaining force between a plurality of retention assemblies formed within a mold and the nail strip;
introducing castable material into the mold and around a portion of the nail strip as the nail strip is restrained by the temporary retaining force;
removing the masonry siding product after the castable material has cured by overcoming the temporary retaining force between the plurality of retention assemblies and the nail strip.

15. The method of claim 14, wherein:
the retention assemblies include magnets; and
the temporary retaining force is a magnetic force.

16. The method of claim 14, including the step of securing the nail strip to the masonry siding product by positioning a portion of the nail strip within the castable material.

17. The method of claim 14, including the step of positioning a portion of the retention assembly to provide a resistive pullout force.

18. The method of claim 14, wherein the mold includes retention nubs configured to prevent movement of the nail strip during the molding process.

19. The method of claim 18, wherein the nail strip includes retention apertures configured to cooperate with the retention nubs.
